(19) United States
(12) Patent Application Publication
(10) Pub. No.: US 2006/0192346 A1
(43) Pub. Date: Aug. 31, 2006

(54) Oil sealing apparatus of wheel bearing

(76) Inventor: In Joon Yeo, Gyeongju-si (KR)

Correspondence Address: ROSENBERG, KLEIN & LEE, 3458 ELLICOTT CENTER DRIVE-SUITE 101, ELLICOTT CITY, MD, 21043, US

(21) Appl. No.: 11/262,718

(22) Filed: Nov. 1, 2005

(30) Foreign Application Priority Data
Feb. 28, 2005 (KR) 10-2005-16531

(51) Int. Cl. F16J 15/32

(52) U.S. Cl. 277/551

(57) ABSTRACT

An oil sealing apparatus of a wheel bearing which can prevent the ingress of contaminating agents into a bearing and can reduce noise occurred by the contaminating agents by reducing abrasion of lips and distortion thereof is disclosed. The oil sealing apparatus includes an outer annular element having a lip, a seal rubber sealing an upper portion of an inner annular element with grease and having a plurality of lips, and grease sealed between the inner annular element and the seal rubber. The outer annular element is interposed in one side of the seal rubber and the lip of the outer annular element is constructed to cover a part of an upper portion of the inner annular element with being spaced apart at a certain interval therefrom.

### BACKGROUND OF THE INVENTION

1. Field of the Invention

The present invention relates to an oil sealing apparatus of a wheel bearing, and more particularly, to an oil sealing apparatus of a wheel bearing which can prevent the ingress of contaminating agents into a bearing and reduce noise caused by the contaminating agents by reducing abrasion of lips and distortion thereof.

2. Background of the Related Art

A conventional wheel of an automobile readily supports the rotation about a suspension by a rolling bearing unit. Also, a rotation speed detector for detecting the rotation speed of a wheel has been assembled to the rolling bearing unit to control an Antilock Brake System (ABS) or a Traction Controller System (TCS).

To construct the rotation speed detector described above by using the rolling bearing unit, it is necessary to assemble a tone wheel into one member (a track wheel on the rotating side) rotating when driving a car between members corresponding to an inner ring and an outer ring. The members includes the rolling bearing unit and the characteristic of the tone wheel changes in turn or at a certain interval through the circumference.

Also, it is necessary to assemble a sealing device into the rolling unit so as to prevent the leak of grease in the sealing device or prevent the ingress of contaminating agents from the surrounding environment. In this case, since the space for assembling a bearing unit is limited, the rolling bearing unit provided with the sealing device and the tone wheel has to be downsized.

Accordingly, there has conventionally been suggested a rolling bearing unit having the structure of combination of a tone wheel and a sealing device (Japanese Patent Laid-Open Publication No. 7-267059). In the conventional structure, a sealing device which is a combined seal ring is constructed by one pair of seal rings attaching a seal lip around the end of a core which is sectionally “L” shaped and entirely in the shape of a ring. Also, a tone wheel is fixed in a part of the core of the seal ling fixed in a member corresponding to an outer ring rotating in use.

However, the rolling bearing unit having the sealing device and the tone wheel described in the Patent Laid-Open Publication No. 7-267059 may cause the seal lip to turn over when an assembly operation is performed and may have difficulty in maintaining the seal lip in a desired direction. Because of this, the security of sealing becomes uncertain. Also, it is difficult to secure the valid width of the tone wheel and to improve the output of a rotation speed detector.

FIG. 3 is a sectional view of a conventional bearing seal. Referring to FIG. 3, grease 106 is filled in an inner annular element 105 and an outer annular element by lips 101, 102, and 103 of a seal rubber 107. In this instance, an amount of filled grease is small. Also, since the structure of the inner annular element 105 is in the shape of opposite “L”, the form of the lip portion 107 becomes simple and a cavity is formed. Thus, this may cause abrasion of a lip and noise occurred by the ingress of a contaminating agent.

### SUMMARY OF THE INVENTION

It is an object of the present invention to provide an oil sealing apparatus of a wheel bearing which can prevent the ingress of dust or dirty water into a cavity of an inner/outer annular element.

It is another object of the present invention to provide an oil sealing apparatus of a wheel bearing which can reduce noise occurred due to abrasion of a track line of an inner/outer ring, the exfoliation of a ball and little friction.

An oil sealing apparatus of a wheel bearing according to the present invention includes an outer annular element having a protrude portion, a seal rubber sealing an upper portion of an inner annular element with grease and having a plurality of lips, and grease sealed between the inner annular element and the seal rubber. The outer annular element is interposed in one side of the seal rubber and the protrude portion of the outer annular element is constructed to cover a part of an upper portion of the inner annular element with being spaced apart at a certain interval therefrom.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a sectional view of an oil sealing apparatus of a wheel bearing according to the present invention;

FIG. 2 is an enlarged sectional view of part A in FIG. 1; and

FIG. 3 is a sectional view of a seal of a conventional wheel bearing.

### DETAILED DESCRIPTION OF THE INVENTION

Hereinafter, an oil sealing apparatus of a wheel bearing according to the present invention will be described in detail with reference to the accompanying drawings.

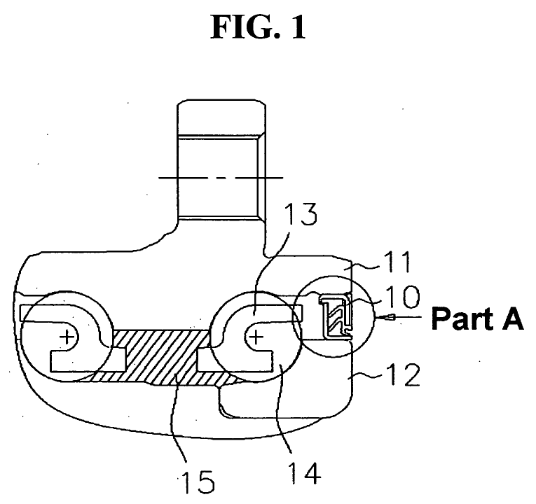

FIG. 1 is a sectional view of an oil sealing apparatus of a wheel bearing according to the present invention. The wheel bearing includes balls 14 interposed between an outer ring 11 of the bearing and an inner ring 12 thereof. The balls 14 are supported by retainers 13. A cavity thereof is filled with grease 15 and sealed by a bearing seal 10.

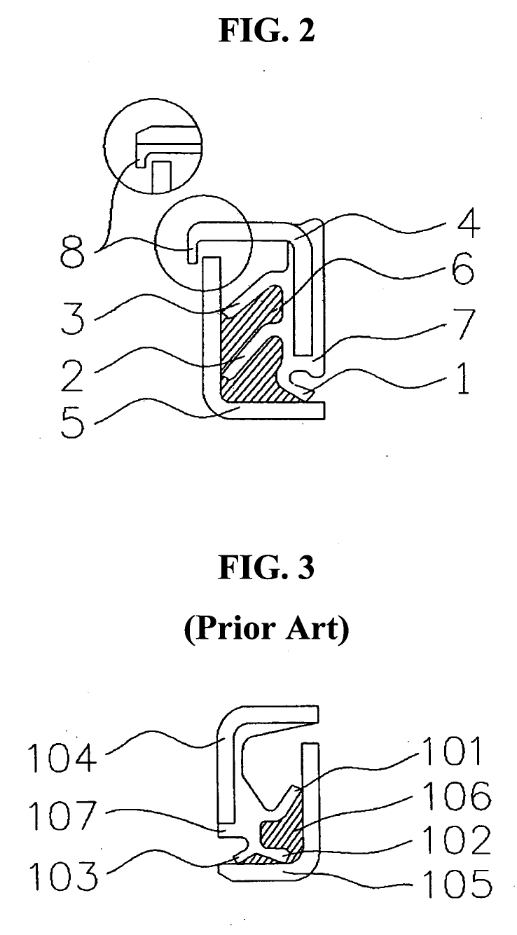

As illustrated in FIG. 2, the bearing seal 10 includes an outer annular element 4, an inner annular element 5, and a seal rubber 7.

A protrude portion 8 for preventing isolation is formed on one end of the outer annular element 4 to cover a part of an upper portion of the inner annular element 5, and the other side of the outer annular element 4 is inserted in the seal rubber 7.

Also, the inner annular element 5 is “L” shaped, and a part of an upper portion of the inner annular element 5 is spaced apart at a certain interval from the protrude portion 8, so that the protrude portion 8 may cover the forward area. Thus, the ingress of contaminating agents can be prevented.

In the meantime, the seal rubber 7 seals an upper portion of the inner annular element 5 with the grease 6 and includes a plurality of lips 1, 2, and 3. The plurality of lips 1, 2, and 3 includes a dust lip 1, a main lip 2, and a sub lip 3. In this instance, the main lip 2 and the sub lip 3 are formed to be parallel with each other and the dust lip 1 is formed to oppose to the main lip 2 and the sub lip 3.

When comparing with a conventional art, according to the present invention, an amount of filled grease is more and the inner annular element 5 itself is provided inside the outer annular element 4. Also, since the seal rubber 7is formed such that the main lip 2 and the sub lip 3 are in parallel with each other, it is possible to prevent the ingress of contaminating agents from the outside. The grease 6 is filled in the inner annular element 5 and the outer annular element 4.

When comparing with the conventional art, in the shape of the seal rubber 7, the dust lip 1 is formed on the outer surface of the inner annular element 5 at a position of the outer annular element 4. Thus, it is possible to prevent caused by the ingress of dust or dirty water in a cavity of inner/outer annular element. Also, it is possible to prevent abrasion or distortion of the dust lip 1 caused by the ingress of dust or dirty water. Also, it is possible to prevent abrasion of a track line of the inner/outer ring 11 or 12, the exfoliation of the ball 14 and little friction.

As described above, an oil sealing apparatus of the wheel bearing according to the present invention can improve the quality and prevent the ingress of contaminating agents such as dust or dirty water into a cavity of inner/outer annular element when a bearing is provided, and prevent abrasion and distortion of lips.

Also, an oil sealing apparatus of a wheel bearing according to the present invention can improve the durability and the life span by reducing noise occurred by abrasion of inner/outer ring of the wheal bearing or exfoliation of balls or friction.

What is claimed is:

1. An oil sealing apparatus of a wheel bearing for automobiles, comprising:
an outer annular element having a protrude portion;
a seal rubber sealing an upper portion of an inner annular element with grease and having a plurality of lips; and
a grease sealed between the inner annular element and the seal rubber,
wherein the outer annular element is interposed in one side of the seal rubber and the protrude portion of the outer annular element is constructed to cover a part of an upper portion of the inner annular element with being spaced apart at a certain interval therefrom.

2. The oil sealing apparatus of claim 1, wherein the protrude portion of the outer annular element is provided to an interior of the seal rubber and prevents isolation of inner and outer annular elements.

3. The oil sealing apparatus of claim 1, wherein a plurality of lips of the seal rubber comprises a dust lip, a main lip, and a sub lip, and the main lip and the sub lip are formed to be parallel with each other and the dust lip is formed to oppose to the main lip and the sub lip.

4. The oil sealing apparatus of claim 3, wherein the dust lip is formed on an outer surface of the inner annular element and prevents the ingress of dust or dirty water into a cavity of the inner and/or outer annular element.
